(19) United States
(12) Patent Application Publication
(10) Pub. No.: US 2024/0251285 A1
(43) Pub. Date: Jul. 25, 2024

(54) DELAY STATUS REPORTING

(71) Applicant: QUALCOMM Incorporated, San Diego, CA (US)

(72) Inventors: Linhai HE, San Diego, CA (US); Sitaramanjaneyulu KANAMARLAPUDI, San Diego, CA (US)

(21) Appl. No.: 18/396,252

(22) Filed: Dec. 26, 2023

Related U.S. Application Data
(60) Provisional application No. 63/481,379, filed on Jan. 24, 2023.

(51) Int. Cl. H04W 28/02; H04L 1/00; H04W 28/04

(52) U.S. Cl. CPC H04W 28/0278; H04L 1/0018; H04W 28/04

(57) ABSTRACT

A user equipment (UE) may buffer data associated with a service. A delay status of the data may include an amount of time left before expiration of a timer (e.g., failure of a particular latency requirement) or an identification of data for which a timer has already expired (e.g., data for which the particular latency requirement has not been met). Some aspects described herein enable delay status reporting. For example, a UE may generate and transmit a delay status report identifying a delay status of data to a network node.

### CROSS-REFERENCE TO RELATED APPLICATION

This Patent Application claims priority to U.S. Provisional Patent Application No. 63/481,379, filed on Jan. 24, 2023, entitled “DELAY STATUS REPORTING.” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for delay status reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G. 5G, and other radio access technologies remain useful.

### SUMMARY

A user equipment (UE) may buffer data associated with a service. For example, the UE may have a buffer associated with data for an extended reality (XR) service being provided by the UE or by one or more XR devices in communication with the UE. The data may be associated with different entities, such as a data radio bearer, a logical channel, or a set of logical channels (e.g., a logical channel group). Some data may be associated with a timing criterion. For example, some data may have a latency requirement as part of a service being provided. In this case. XR service may be associated with a particular latency requirement and data associated with the XR service may be subject to the particular latency requirement. In some examples, a delay status of the data may include an amount of time left before expiration of a timer (e.g., failure of a particular latency requirement) or an identification of data for which a timer has already expired (e.g., data for which the particular latency requirement has not been met). A network node may schedule communication resources to ensure that data is not delayed. However, the network node may lack information regarding the data and/or a communication delay associated with the data.

Some aspects described herein enable delay status reporting. For example, a UE may receive information identifying a set of criteria for generating a delay status report and may, when the set of criteria is satisfied, generate and transmit the delay status report to a network node. In this case, the network node may use the delay status report to configure communications on a network, such as by scheduling resources, balancing loads, or changing quality of service parameters, among other examples. In this way, the UE and the network node can improve services being provided on the network, such as by scheduling additional resources to improve XR service latency when XR data is delayed.

Some aspects described herein relate to a method of wireless communication performed by a UE. The method may include receiving information identifying a set of criteria for delay status reporting. The method may include transmitting, based at least in part on the set of criteria being satisfied, a delay status report including an indicator of a data volume and a delay status associated with the data volume.

Some aspects described herein relate to a method of wireless communication performed by a network node. The method may include transmitting information identifying a set of criteria for delay status reporting. The method may include receiving, based at least in part on the set of criteria being satisfied, a delay status report including an indicator of a data volume and a delay status associated with the data volume.

Some aspects described herein relate to a UE for wireless communication. The user equipment may include a memory and one or more processors coupled to the memory. The one or more processors may be configured to receive information identifying a set of criteria for delay status reporting. The one or more processors may be configured to transmit, based at least in part on the set of criteria being satisfied, a delay status report including an indicator of a data volume and a delay status associated with the data volume.

Some aspects described herein relate to a network node for wireless communication. The network node may include a memory and one or more processors coupled to the memory. The one or more processors may be configured to transmit information identifying a set of criteria for delay status reporting. The one or more processors may be configured to receive, based at least in part on the set of criteria being satisfied, a delay status report including an indicator of a data volume and a delay status associated with the data volume.

Some aspects described herein relate to a non-transitory computer-readable medium that stores a set of instructions for wireless communication by a UE. The set of instructions, when executed by one or more processors of the UE, may cause the UE to receive information identifying a set of criteria for delay status reporting. The set of instructions, when executed by one or more processors of the UE, may cause the UE to transmit, based at least in part on the set of criteria being satisfied, a delay status report including an indicator of a data volume and a delay status associated with the data volume.

Some aspects described herein relate to a non-transitory computer-readable medium that stores a set of instructions for wireless communication by a network node. The set of instructions, when executed by one or more processors of the network node, may cause the network node to transmit information identifying a set of criteria for delay status reporting. The set of instructions, when executed by one or more processors of the network node, may cause the network node to receive, based at least in part on the set of criteria being satisfied, a delay status report including an indicator of a data volume and a delay status associated with the data volume.

Some aspects described herein relate to an apparatus for wireless communication. The apparatus may include means for receiving information identifying a set of criteria for delay status reporting. The apparatus may include means for transmitting, based at least in part on the set of criteria being satisfied, a delay status report including an indicator of a data volume and a delay status associated with the data volume.

Some aspects described herein relate to an apparatus for wireless communication. The apparatus may include means for transmitting information identifying a set of criteria for delay status reporting. The apparatus may include means for receiving, based at least in part on the set of criteria being satisfied, a delay status report including an indicator of a data volume and a delay status associated with the data volume.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a timing for delay status reporting, in accordance with the present disclosure.

FIGS. 5A and 5B are diagrams illustrating an example associated with delay status reporting, in accordance with the present disclosure.

FIG. 6 is a flowchart of an example method of wireless communication, in accordance with the present disclosure.

FIG. 7 is a flowchart of an example method of wireless communication, in accordance with the present disclosure.

FIG. 8 is a diagram of an example apparatus for wireless communication, in accordance with the present disclosure.

FIG. 9 is a diagram illustrating an example of a hardware implementation for an apparatus employing a processing system, in accordance with the present disclosure.

FIG. 10 is a diagram of an example apparatus for wireless communication, in accordance with the present disclosure.

FIG. 11 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

A user equipment (UE) may buffer data associated with a service. For example, the UE may have a buffer associated with data for an extended reality (XR) service being provided by the UE or by one or more XR devices in communication with the UE. A delay status of the data may include an amount of time left before expiration of a timer (e.g., failure of a particular latency requirement) or an identification of data for which a timer has already expired (e.g., data for which the particular latency requirement has not been met). A network node may schedule communication resources to ensure that data is not delayed. However, the network node may lack information regarding the data and/or a communication delay associated with the data.

Various aspects relate generally to delay status reporting. Some aspects more specifically relate to generation of a delay status report and transmission of a delay status report. In some aspects, a UE may receive information identifying a set of criteria for generating a delay status report. In some aspects, the UE may determine that the set of criteria is satisfied and generate a delay status report in connection with determining that the set of criteria is satisfied. In some aspects, the UE may transmit the delay status report to a network node. The network node may use the delay status report to configure communications on a network, such as by scheduling resources, balancing loads, or changing quality of service parameters, among other examples.

Particular aspects of the subject matter described in this disclosure can be implemented to realize one or more of the following potential advantages. In some examples, by the UE generating and transmitting a delay status report in connection with satisfaction of a set of configured criteria, the UE and the network node can improve services being provided on the network. For example, the described techniques can enable scheduling of additional resources to improve XR service latency when, for example, XR data is delayed.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

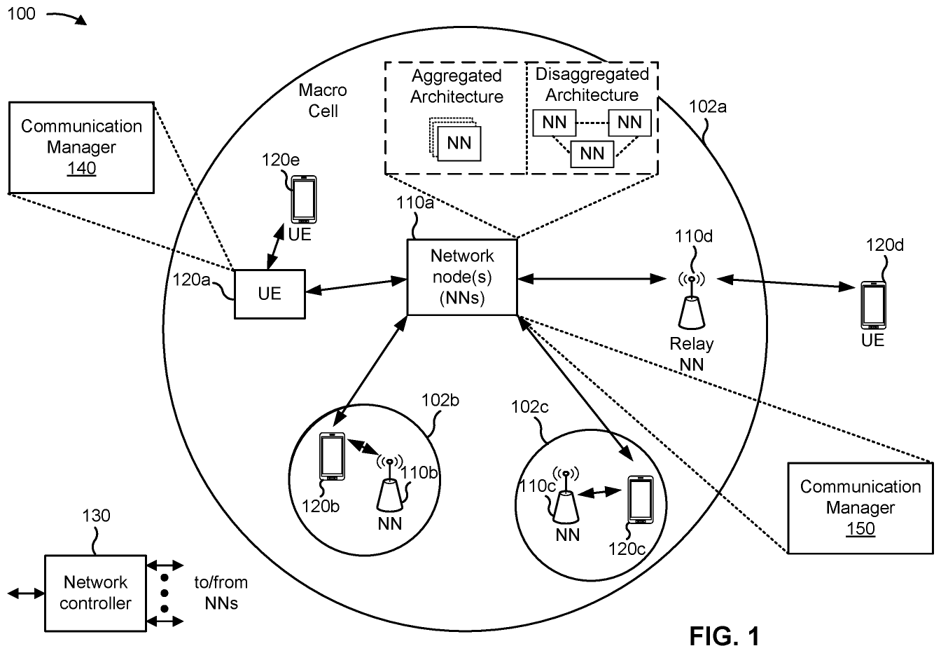

FIG. 1 is a diagram illustrating an example of a wireless network 100. The wireless network 100 may be or may include elements of a 5G (for example, NR) network or a 4G (for example. Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects. “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IOT) devices, or may be implemented as NB-IOT (narrow band IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases. NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHz.” if used herein, may broadly represent frequencies that may be less than 6 GHZ, may be within FR1, or may include mid-band frequencies. Further, unless specifically stated otherwise, the term “millimeter wave.” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive information identifying a set of criteria for delay status reporting: and transmit, based at least in part on the set of criteria being satisfied, a delay status report including an indicator of a data volume and a delay status associated with the data volume. Additionally, or alternatively, the communication manager 140 may perform one or more other operations described herein.

In some aspects, the network node 110 may include a communication manager 150. As described in more detail elsewhere herein, the communication manager 150 may transmit information identifying a set of criteria for delay status reporting: and receive, based at least in part on the set of criteria being satisfied, a delay status report including an indicator of a data volume and a delay status associated with the data volume. Additionally, or alternatively, the communication manager 150 may perform one or more other operations described herein.

As indicated above. FIG. 1 is provided as an example. Other examples may differ from what is described with regard to FIG. 1.

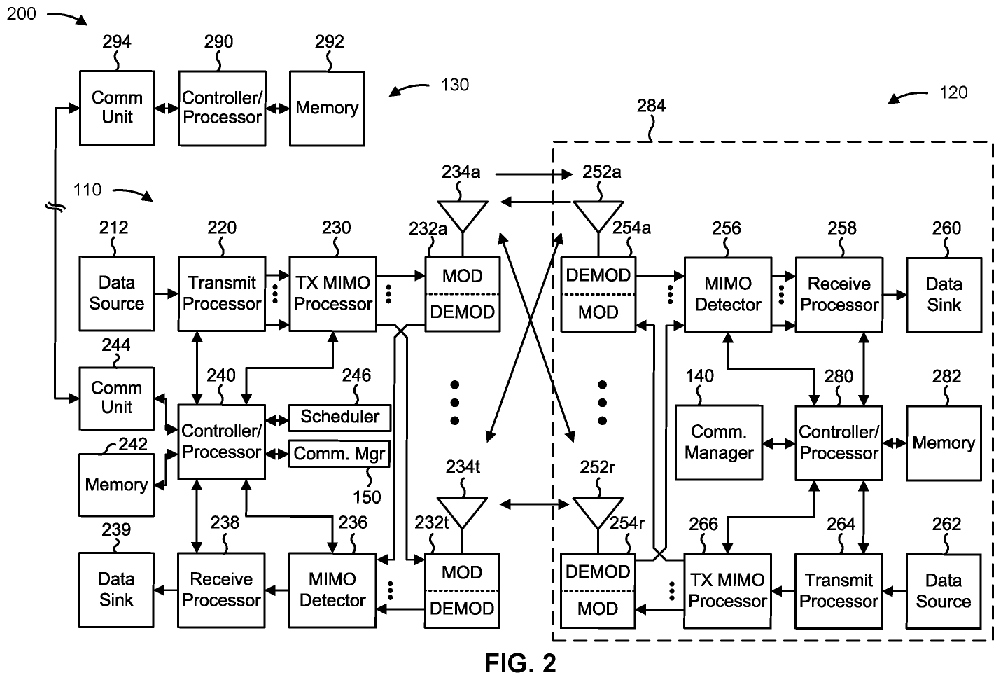

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

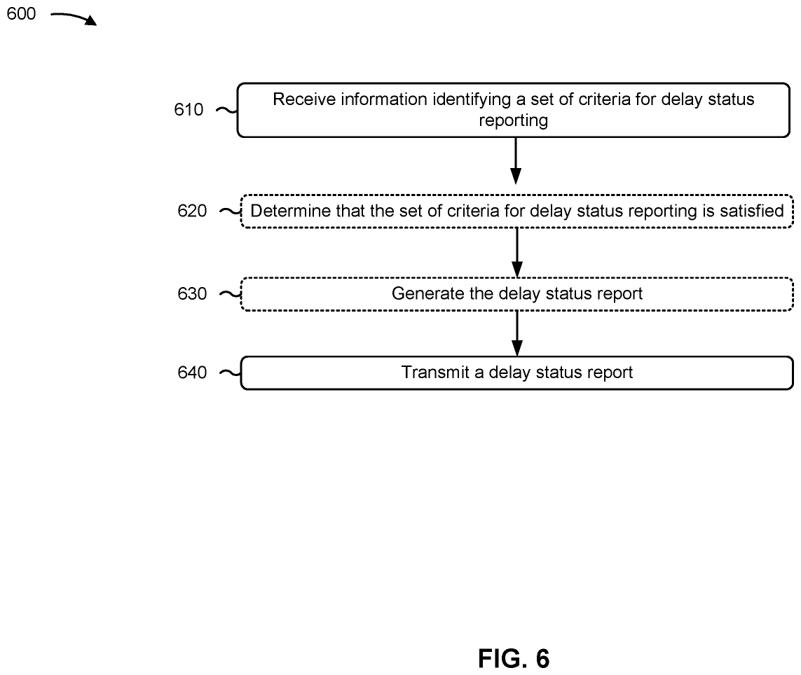

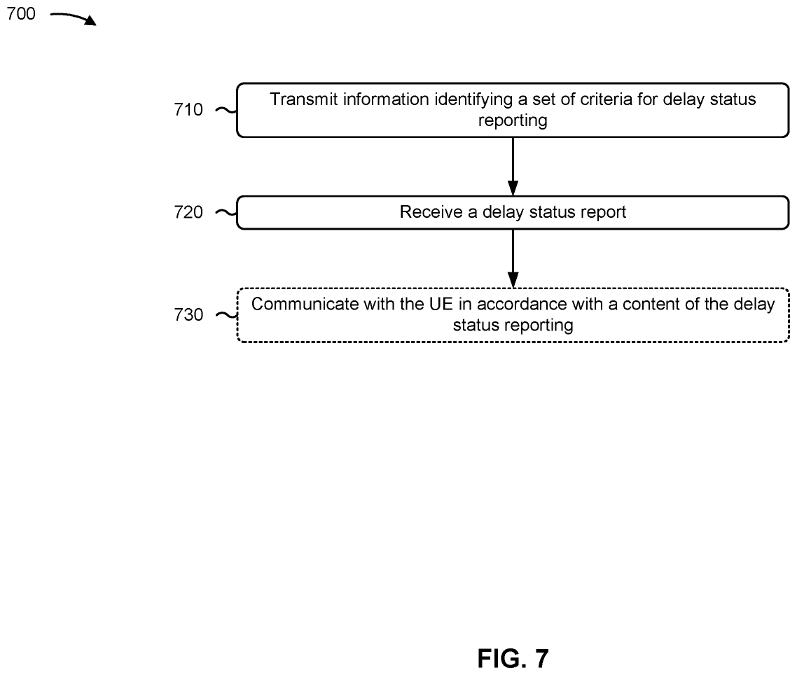

The controller/processor 240 of the network node 110, the controller/processor 280 of the UE 120, and/or any other component(s) of FIG. 2 may perform one or more techniques associated with delay status reporting, as described in more detail elsewhere herein. For example, the controller/processor 240 of the network node 110, the controller/processor 280 of the UE 120, and/or any other component(s) of FIG. 2 may perform or direct operations of, for example, method 600 of FIG. 6, method 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, method 600 of FIG. 6, method 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving information identifying a set of criteria for delay status reporting: and/or means for transmitting, based at least in part on the set of criteria being satisfied, a delay status report including an indicator of a data volume and a delay status associated with the data volume. The means for the UE 120 to perform operations described herein may include, for example, one or more of communication manager 140, antenna 252, modem 254. MIMO detector 256, receive processor 258, transmit processor 264. TX MIMO processor 266, controller/processor 280, or memory 282.

In some aspects, the network node 110 includes means for transmitting information identifying a set of criteria for delay status reporting: and/or means for receiving, based at least in part on the set of criteria being satisfied, a delay status report including an indicator of a data volume and a delay status associated with the data volume. The means for the network node 110 to perform operations described herein may include, for example, one or more of communication manager 150, transmit processor 220. TX MIMO processor 230, modem 232, antenna 234. MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU. DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

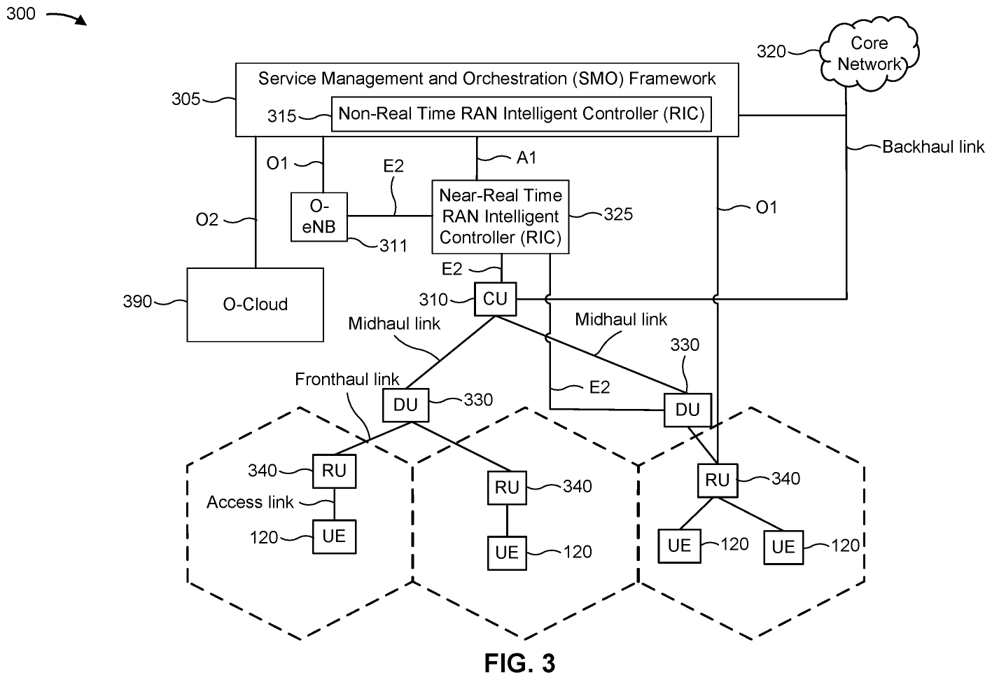

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example. Central Unit-User Plane (CU-UP) functionality), control plane functionality (for example. Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources. Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above. FIG. 3 is provided as an example. Other examples may differ from what is described with regard to FIG. 3.

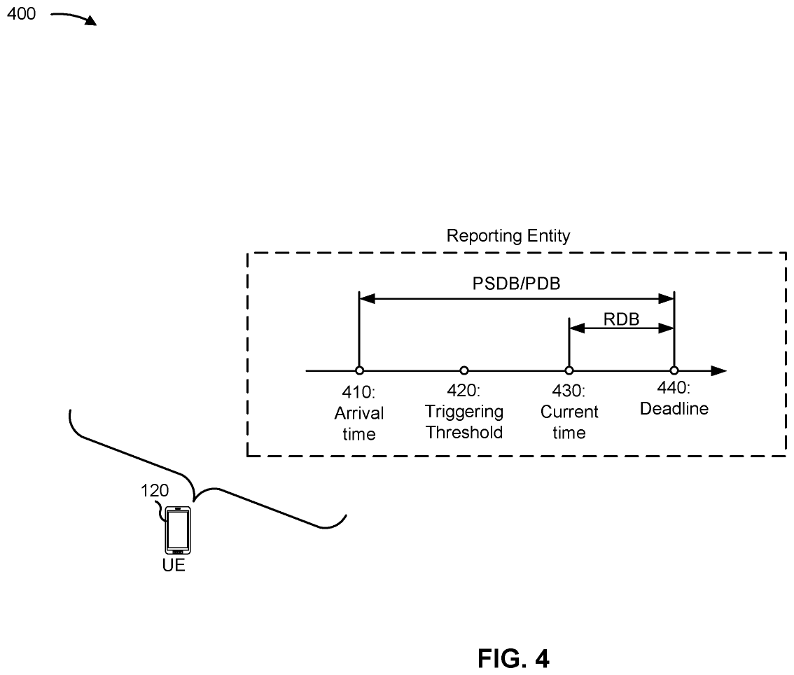

FIG. 4 is a diagram illustrating an example 400 of a timing for delay status reporting, in accordance with the present disclosure.

As shown in FIG. 4, a reporting entity may be configurable with a timeline for delay status reporting (DSR), which may also be referred to as “delay information reporting (DIR)”. The reporting entity may be an entity for which a UE 120 reports delay information in a DSR message. For example, the reporting entity may be a data radio bearer (DRB), a logical channel (LCH), or a set of logical channels (e.g., a logical channel group (LCG)). In some examples, a DRB may include a plurality of LCHs corresponding to a plurality of protocol data unit (PDU) sets, each including one or more PDUs with a common parameter (e.g., an importance level parameter). A UE 120 may be configured with a plurality of reporting entities, in some examples.

As further shown in FIG. 4, the timeline for delay status reporting may be based at least in part on an arrival time 410. The arrival time 410 may include a time at which a first PDU of a PDU set is received by the UE 120. In some examples, the first received PDU may be different than a first indexed PDU (e.g., as a result of out of order delivery of PDUs). An amount of remaining time for a PDU may be associated with a PDU set delay budget (PSDB) or a packet delay budget (PDB). For example, the UE 120 (or the reporting entity thereof) may be configured with a PSDB timer, which represents an amount of time after the arrival time 410 during which a PDU set can be delivered from the UE 120 to a destination device (e.g., a network node (not shown)). Similarly, the UE 120 may be configured with a PDB timer, which represents an amount of time after the arrival time 410 during which a PDU (e.g., which is not associated with a PDU set) can be delivered from the UE 120 to a destination device (e.g., before a failure occurs).

The UE 120 may be configured with a time threshold 420 (T_{DIR,m}) for a reporting entity m. The time threshold 420 may be configured as an absolute time or a percentage of time between the arrival time 410 and an end of the PSDB or PDB. However, a network node 110 and UE 120 may lack signaling for exchanging or synchronizing a configuration relating to a reporting timeline of a reporting entity. For example, the UE 120 may not be configured with information indicating a triggering threshold from which the UE 120 can determine whether the triggering threshold is satisfied at the time threshold 420. Accordingly, the UE 120 and network node 110 may not be synchronized at a current time 430 and evaluate whether a deadline 440 has occurred.

As indicated above. FIG. 4 is provided as an example. Other examples may differ from what is described with respect to FIG. 4.

Some aspects described herein enable delay status reporting. For example, a UE may receive information identifying a set of criteria for generating a delay status report and may, when the set of criteria is satisfied, generate and transmit the delay status report to a network node. In this case, the network node may use the delay status report to configure communications on a network, such as by scheduling resources, balancing loads, or changing quality of service parameters, among other examples. In this way, the UE and the network node can improve services being provided on the network, such as by scheduling additional resources to improve XR service latency when XR data is delayed. In some aspects, by enabling configuration of a reporting entity (e.g., a UE 120), a network node and a UE may maintain synchronization, thereby enabling efficient allocation of resources for transmitting data associated with one or more services.

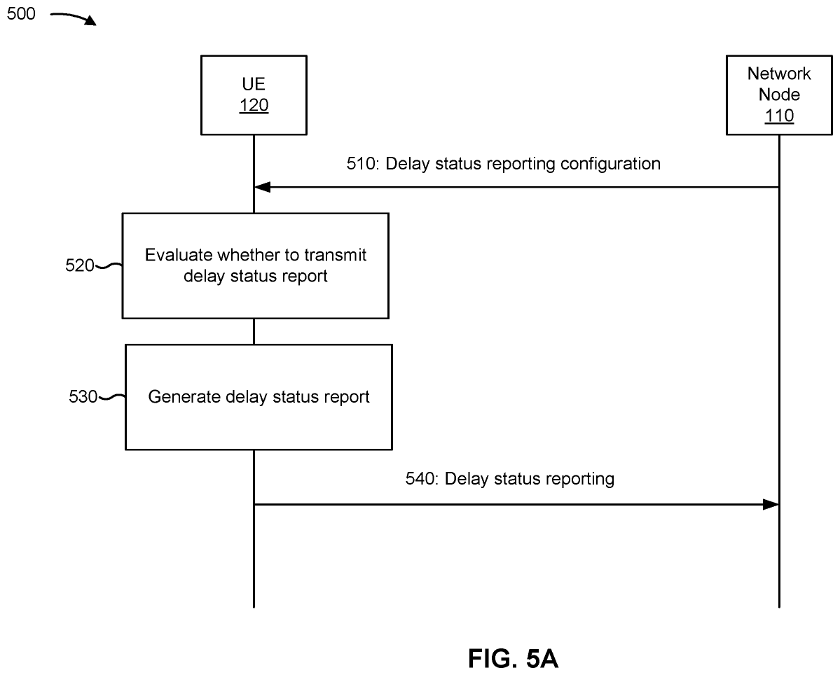

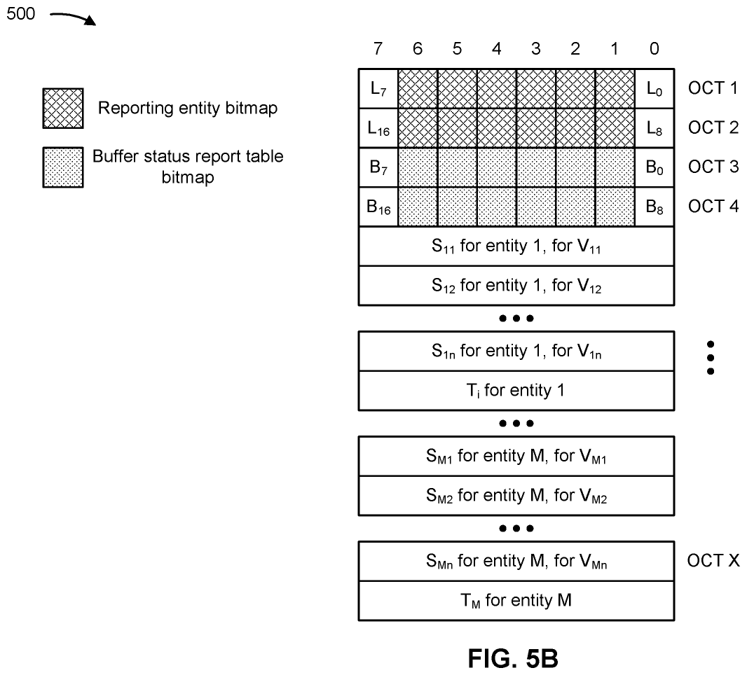

FIGS. 5A and 5B are diagrams illustrating an example 500 associated with delay status reporting, in accordance with the present disclosure. As shown in FIGS. 5A and 5B, example 500 includes communication between a network node 110 and a UE 120.

As further shown in FIG. 5A, and by reference number 510, the UE 120 may receive information identifying a delay status reporting configuration. For example, the UE 120 may receive, from the network node 110, information identifying a set of criteria for delay status reporting. The set of criteria for delay status reporting may include one or more parameter values, such as one or more values for a delay deadline, a data volume threshold, an amount of time for a prohibit timer, a reporting threshold, or another configurable parameter, as described herein. In some aspects, the UE 120 may receive information identifying a parameter for determine whether a delay deadline is satisfied. For example, the UE 120 may receive information identifying a PSDB. In this case, the UE 120 may determine an amount of time remaining to transmit a delay status report based at least in part on a delay deadline (e.g., which is a function of the PSDB) and a current time (e.g., at which the UE 120 is evaluating whether to transmit the delay status report). Additionally, or alternatively, the UE 120 may receive information identifying a PDB for determining the delay deadline for PDUs not included in a PDU set. In some aspects, the PDB may be configured based on a quality of service (QOS) flow specific basis. For example, the UE 120 may receive information indicating a PDB for a particular QoS flow (and PDUs thereof). A QoS flow may refer to one or more data packets associated with a specific PDU and/or data radio bearer (DRB) and associated with one or more QoS parameters, such as a level of priority, a data rate, or a latency, among other examples. Accordingly, the UE 120 may have a plurality of QoS flows for receiving traffic from a network (e.g., the network node 110) and may have a PDB for each QoS flow (e.g., a different PDB or the same PDB). The PDB may be a QoS characteristic that specifies an upper bound for an amount of time that a packet may be delayed between a network source, associated with the network node 110, and the UE 120. For example, a particular QOS flow may be configured with a 2 millisecond (ms) PDB, which indicates that packets can be delayed up to 2 ms when being conveyed from, for example, a user plane function (UPF) (e.g., via the network node 110) to a UE 120

In some aspects, the UE 120 may receive information identifying a time threshold. For example, the UE 120 may receive information indicating the time threshold T_{DIR,m} associated with a reporting entity m of the UE 120. In this case, the UE 120 may evaluate whether the time threshold is satisfied to determine whether to generate and transmit a delay status report for the reporting entity m, as described herein. Additionally, or alternatively, the UE 120 may receive information identifying a data volume threshold. V_{prohibit}, which represents a data volume to accumulate in a buffer before a delay status report is triggered. In this case, the value of V_{prohibit} is configurable to control often the UE 120 triggers delay status reports (e.g., a higher value of V_{prohibit} reduces a frequency of delay status reports, thereby reducing a utilization of network resources, a lower value of V_{prohibit} increases a frequency of delay status reports, thereby reducing delay). A data volume may include an amount of data (e.g., a quantity of packets, a quantity of bits, or another data metric) that, for example, is accumulated in a buffer.

Additionally, or alternatively, the UE 120 may receive information identifying a time threshold. T_{prohibit}, Which represents a time period in which the UE 120 does not trigger delay status reports. In this case, the value of T_{prohibit} is configurable to control often the UE 120 triggers delay status reports (e.g., a higher value of T_{prohibit} reduces a frequency of delay status reports, thereby reducing a utilization of network resources, a lower value of T_{prohibit} increases a frequency of delay status reports, thereby reducing delay).

As further shown in FIG. 5A, and by reference numbers 520 and 530, the UE 120 may evaluate whether to transmit a delay status report and may generate the delay status report. For example, the UE 120 may determine whether the set of criteria for delay status reporting is satisfied and may, when the set of criteria is satisfied, generate a delay status report identifying a status of a buffer.

In some aspects, the UE 120 may determine whether a delay deadline is satisfied. For example, the UE 120 may determine whether the delay deadline is satisfied for one or more PDUs. In some aspects, a PDU may be included in a PDU set. When a PDU is included in a PDU set, the UE 120 may determine the delay deadline based at least in part on a time at which a first PDU of the PDU set is received by the UE. For example, the UE 120 may receive a first PDU of a PDU set (e.g., which may or may not be a first index PDU of the PDU set) at a time T₁ and may determine the delay deadline T_{deadline}=T₁+T₂, where T₂ represents a PSDB of a QoS flow that includes the received first PDU. Accordingly, the UE 120 may determine whether a remaining time to transmit a delay status report as T_{remaining}=T_{deadline}−T_{current}. Where T_{current} represents a time at which the UE 120 is evaluating whether to transmit a delay status report. Alternatively, when a received PDU is not included in a PDU set, the UE 120 may determine the delay deadline based at least in part on a PDB. For example, the UE 120 may receive a PDU and determine T_{deadline}=T₁+T₂, where T₁ represents a time at which the PDU is received and T₂ represents the PDB for a QOS flow that includes the PDU.

In some aspects, the UE 120 may determine whether a time threshold for reporting a delay status is satisfied. For example, a reporting entity m of the UE 120 (e.g., the UE 120 may include a plurality of reporting entities corresponding to a plurality of applications or QoS flows) may be configured with a time threshold T_{DIR,m} that, when satisfied, may trigger the UE 120 to transmit a delay status report.

In some aspects, the UE 120 may determine whether a data volume threshold is satisfied to determine whether to generate and transmit a delay status report. For example, the UE 120 determine whether a data volume in a buffer associated with a reporting entity satisfies a threshold V_{prohibit}. In some aspects, the UE 120 may determine whether a delay status report is to be triggered for a slot. For example, the UE 120 may determine S_{urgent}, Which represents a data volume with a remaining time less than T_{DIR} (if T_{DIR} is configured as an absolute time). Additionally, or alternatively, the UE 120 may determine S_{urgent} as a data volume with a remaining time below T_{DIR}×PSDB or T_{DIR}×PDB (if T_{DIR} is configured as a percentage). Additionally, or alternatively, the UE 120 may determine a data volume. S_{ref} reported in a previously triggered delay status report (e.g., if a previous delay status report has occurred, otherwise S_{ref} may be set to a default value, such as 0). In this case, when the UE 120 evaluates S_{urgent}−S_{ref}>V_{prohibit}, the UE 120 may trigger a delay status report. In other words, the UE 120 determines whether difference between a current data volume, with a remaining time less than a time threshold, and a previously reported data volume, with a remaining time less than the time threshold, is greater than a threshold amount.

Similarly, the UE 120 may determine whether to generate and transmit a delay status report based at least in part on whether a prohibit timer T_{prohibit} is active. For example, when the prohibit timer is not active (e.g., the UE 120 is not prohibited from triggering a delay status report), the UE 120 can trigger a delay status report. In this case, the UE 120 may start the prohibit timer when a delay status report is triggered and may forgo triggering further delay status reports until after the prohibit timer has elapsed or after a delay status report MAC control element (CE) (MAC CE) is transmitted via a physical uplink shared channel (PUSCH).

In some aspects, the UE 120 may determine whether to generate and transmit a delay status report based at least in part on a configured periodicity. For example, the network node 110 may configure periodic reporting of a delay status of the UE 120. In this case, the network node 110 may configure delay status reporting to occur in each time period t, which may be a configurable parameter (e.g., configured via network node 110 radio resource control (RRC) signaling, such as a configuration information element (IE)) or a static parameter (e.g., that is in a specification, such as specifying a periodicity of delay status reporting occurring (or potentially occurring) in each slot). In some aspects, the network node 110 may enable or disable periodic reporting on, for example, a per reporting entity basis. For example, the network node 110 may configure, using static signaling, periodic delay status reporting and may select, by transmitting a MAC CE, one or more reporting entities of a UE 120 for which the UE 120 is to perform the periodic delay status reporting. In some aspects, the UE 120 may determine whether to generate and transmit a delay status report based at least in part on an occurrence of a mobility event. For example, the mobility event may occur when the UE 120 changes a primary cell (PCell) (e.g., as a result of a handover) or a primary secondary cell (PSCell) (e.g., as a result of a secondary cell group (SCG) change). Based on these events, the UE 120 may trigger a delay status report to indicate to a new cell (e.g., the network node 110) a delay status of one or more reporting entities of the UE 120.

In some aspects, the UE 120 may evaluate one or more reporting thresholds for one or more reporting entities, m, when generating a delay status report. For example, the UE 120 may evaluate a reporting threshold V_{m,1}, . . . , V_{m,m}, where n represents a quantity of intervals for reporting. In other words, the UE 120 may determine to report buffered data with a remaining time between V_{m,i} and V_{m,i+1} for i=1 . . . . n. For example, the UE 120 may generate a MAC CE, as shown in FIG. 5B, conveying information associated with a set of reporting thresholds. In this case, a set of reporting entities and a set of values that the UE 120 reports in the MAC CE may be based at least in part on, for example, the configuration information.

As further shown in FIG. 5B, the MAC CE may include a bitmap Lₘ that indicates whether a reporting entity m is being reported in the MAC CE. In this case, the bitmap Lₘ has a size of 2×B (e.g., if the reporting entity of the UE 120 is a DRB or LCH) or 1×B, where B represents a quantity of reporting entities m. The MAC CE may further include a parameter Bₘ, which indicates which buffer status report table, of a set of possible buffer status report tables, is being used for reporting a data volume. In this case, the UE 120 may include the parameter Bₘ, when the UE 120 is configured with a plurality of classes of BSR tables, such as enhanced 3GPP Release 18 specified BSR tables and pre-Release 18 BSR tables. The UE 120 may include, for each reporting entity being reported, a parameter S_{m,i}, which represents a data volume buffered for reporting entity m with a remaining time between V_{m,i} and V_{m,j+1} (e.g., for j=1, . . . , n). In some aspects, the UE 120 may encode the parameter S_{m,j} using a specified BSR table, as described above and, for example, indicated with Bₘ.

In some aspects, the UE 120 may include a parameter Tₘ indicating a duration between a sampling instance (e.g., when the UE 120 determines a delay status) and a transmission time of a PUSCH that includes the delay status report. For example, the UE 120 may indicate a quantity of slots indicating a time duration between an identification of the delay status and reporting of the delay status. In some aspects, the sampling instance may represent a slot in which a delay status report is triggered. In some aspects, the sampling instance may represent a slot in which a MAC PDU including the delay status report is generated. In this case, the UE 120 may select reporting entities and/or reported values for the reporting entities based at least in part on which sampling instance is used.

As further shown in FIG. 5A, and by reference number 540, the UE 120 may transmit delay status reporting. For example, the UE 120 may transmit a delay status report to the network node 110. In this case, the UE 120 may transmit a MAC CE, as described herein, using a PUSCH resource for transmitting the MAC CE. In some aspects, the UE 120 may transmit the delay status reporting with a particular priority. For example, a delay status report MAC CE may be associated with a higher logical channel prioritization (LCP) priority value than is assigned to a buffer status report. In other words, the delay status report MAC CE may have a first priority that is higher than a second priority of a buffer status report message, which may result in the delay status report MAC CE being prioritized for receiving uplink resources for transmission.

In some aspects, when there is a PUSCH resource available and the UE 120 has a pending delay status report for transmission, the UE 120 may multiplex the delay status report onto the PUSCH for transmission. For example, the UE 120 may piggyback the delay status report with one or more other communications that are to be conveyed via the PUSCH resource. Additionally, or alternatively, to convey the delay status report in the PUSCH resource, the UE 120 may puncture the PUSCH resource and overwrite one or more other communications that are to be conveyed via the PUSCH resource. Alternatively, the UE 120 may request PUSCH resources from the network node 110 via a scheduling request (SR). In this case, the network node 110 may configure dedicated physical uplink control channel (PUCCH) resources for transmitting SRs to request resources for, for example, transmission of delay status reports.

In some aspects, the UE 120 may start or stop a prohibit timer in connection with transmitting the MAC CE. For example, the UE 120 may stop a running prohibit timer T_{prohibit} when transmitting the MAC CE to enable generation of a new, updated a delay status report. Additionally, or alternatively, the UE 120 may cancel one or more other pending delay status reports. In some aspects, the UE 120 may receive an allocation of resources. For example, based at least in part on transmitting the delay status report, the UE 120 may receive, from the network node 110, information identifying an allocation of resources for transmitting data reported in the delay status report.

As indicated above. FIGS. 5A and 5B is provided as an example. Other examples may differ from what is described with respect to FIGS. 5A and 5B.

FIG. 6 is a flowchart of an example method 600 of wireless communication. The method 600 may be performed by, for example, a UE (e.g., UE 120).

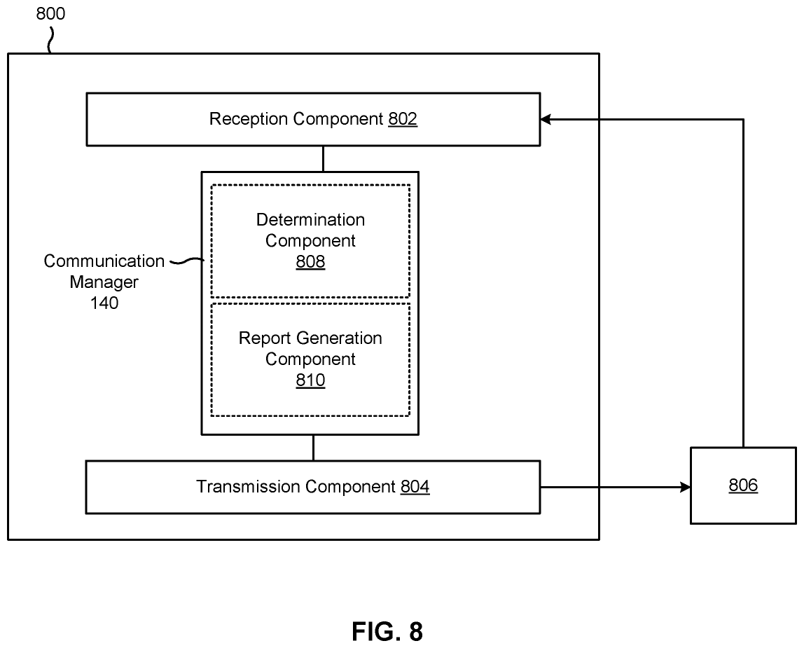

At 610, the UE may receive information identifying a set of criteria for delay status reporting. For example, the UE (e.g., using communication manager 140 and/or reception component 802, depicted in FIG. 8) may receive information identifying a set of criteria for delay status reporting, as described above. In some aspects, the UE is configured to receive signaling associated with configuring one or more parameters of the delay status report. In some aspects, the one or more parameters include at least one of a data volume threshold parameter, a timer parameter, or one or more reporting thresholds.

At 620, in some aspects, the UE may determine that the set of criteria for delay status reporting is satisfied. For example, the UE (e.g., using communication manager 140 and/or determination component 808, depicted in FIG. 8) may determine that the set of criteria for delay status reporting is satisfied, as described above. In some aspects, the UE may determine that the set of criteria for delay status reporting is satisfied based at least in part on determining that a timer has expired or that a data volume in a buffer satisfies a threshold.

At 630, in some aspects, the UE may generate the delay status report. For example, the UE (e.g., using communication manager 140 and/or report generation component 810, depicted in FIG. 8) may generate, based at least in part on determining that the set of criteria for delay status reporting is satisfied, the delay status report, as described above. In some aspects, the delay status report is associated with a first priority that is higher than a second priority of a buffer status report. In some aspects, the delay status report is multiplexed onto a physical uplink shared channel resource. In some aspects, the delay status report is included in a physical uplink shared channel resource requested via a scheduling request.

At 640, the UE may transmit, based at least in part on the set of criteria being satisfied, a delay status report including an indicator of a data volume and a delay status associated with the data volume. For example, the UE (e.g., using communication manager 140 and/or transmission component 804, depicted in FIG. 8) may transmit, based at least in part on the set of criteria being satisfied, a delay status report including an indicator of a data volume and a delay status associated with the data volume, as described above.

In some aspects, the delay status reporting is associated with at least one of a data radio bearer, a logical channel, or a logical channel group. In some aspects, the delay status is based at least in part on a delay deadline for a protocol data unit associated with the data volume or on a packet delay budget associated with a quality of service flow, the quality of service flow including the protocol data unit. In some aspects, the delay status is based at least in part on a time threshold for triggering generation of the delay status report or for reporting the delay status report. In some aspects, the delay status report is based at least in part on whether a threshold data volume is associated with a remaining time, wherein the remaining time is less than a time threshold.

In some aspects, the delay status report is based at least in part on a data volume reported in a previous delay status report. In some aspects, the delay status report is based at least in part on a status of a timer. In some aspects, alone or in combination with one or more of the first through ninth aspects, the timer is stopped based at least in part on transmission of the delay status report.

In some aspects, the delay status report is based at least in part on a configured periodicity. In some aspects, the configured periodicity is associated with a reporting entity. In some aspects, the delay status report is based at least in part on an occurrence of a mobility event. In some aspects, the delay status report is included in a MAC CE. In some aspects, the MAC CE includes at least one of a delay status report reporting entity bitmap, a buffer status report table bitmap, an indicator of data with a remaining time within a configured range, an indicator of data with a remaining time less than a threshold, an indicator that the MAC CE is for a reporting entity, an indicator of a buffer status report table, a sampling instance duration indicator, or a transmission time indicator.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a flowchart of an example method 700 of wireless communication. The method 700 may be performed by, for example, a network node (e.g., network node 110).

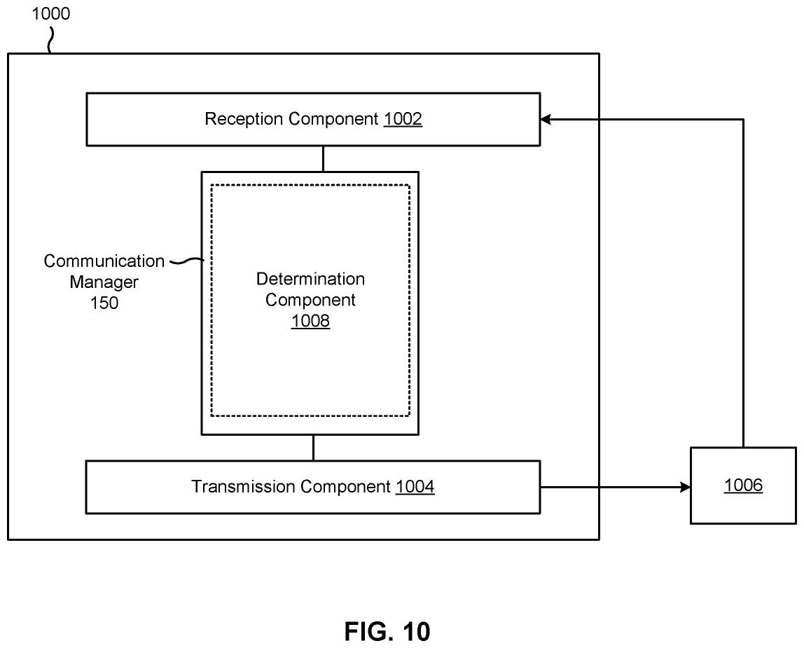

At 710, the network node may transmit information identifying a set of criteria for delay status reporting. For example, the network node (e.g., using communication manager 150 and/or transmission component 1004, depicted in FIG. 10) may transmit information identifying a set of criteria for delay status reporting, as described above. In some aspects, the delay status reporting is associated with at least one of a data radio bearer, a logical channel, or a logical channel group. In some aspects, the network node may transmit signaling associated with configuring one or more parameters of the delay status report. In some aspects, the one or more parameters include at least one of a data volume threshold parameter, a timer parameter, or one or more reporting thresholds.

At 720, the network node may receive a delay status report. For example, the network node (e.g., using communication manager 150 and/or reception component 1002, depicted in FIG. 10) may receive, based at least in part on the set of criteria being satisfied, a delay status report including an indicator of a data volume and a delay status associated with the data volume, as described above. In some aspects, the delay status is based at least in part on a delay deadline for a protocol data unit associated with the data volume or on a packet delay budget associated with a quality of service flow, the quality of service flow including the protocol data unit. In some aspects, the delay status is based at least in part on a time threshold for triggering generation of the delay status report or for reporting the delay status report. In some aspects, the delay status report is based at least in part on whether a threshold data volume is associated with a remaining time, wherein the remaining time is less than a time threshold.

In some aspects, the delay status report is based at least in part on a data volume reported in a previous delay status report. In some aspects, the delay status report is based at least in part on a status of a timer. In some aspects, the timer is stopped based at least in part on transmission of the delay status report. In some aspects, the delay status report is based at least in part on a configured periodicity.

In some aspects, the configured periodicity is associated with a reporting entity. In some aspects, the delay status report is based at least in part on an occurrence of a mobility event. In some aspects, the delay status report is included in a MAC CE. In some aspects, the MAC CE includes at least one of a delay status report reporting entity bitmap, a buffer status report table bitmap, an indicator of data with a remaining time within a configured range, an indicator of data with a remaining time less than a threshold, an indicator that the MAC CE is for a reporting entity, an indicator of a buffer status report table, a sampling instance duration indicator, or a transmission time indicator. In some aspects, the delay status report is associated with a first priority that is higher than a second priority of a buffer status report. In some aspects, the delay status report is multiplexed onto a physical uplink shared channel resource. In some aspects, the delay status report is included in a physical uplink shared channel resource requested via a scheduling request.

At 730, in some aspects, the network node may communicate with the UE in accordance with a content of the delay status reporting. For example, the network node (e.g., using communication manager 150, reception component 1002, and/or transmission component 1004, depicted in FIG. 10) may communicate with the UE in accordance with a content of the delay status reporting. In some aspects, the network node may schedule resources for the UE and/or an XR device associated therewith based at least in part on the content of the delay status reporting.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a determination component 808 or a report generation component 810, among other examples.

In some aspects, the apparatus 800 may be configured to perform one or more operations described herein, such as one or more operations described with regard to FIGS. 5A and 5B. Additionally, or alternatively, the apparatus 800 may be configured to perform one or more processes described herein, such as method 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive information identifying a set of criteria for delay status reporting. The transmission component 804 may transmit, based at least in part on the set of criteria being satisfied, a delay status report including an indicator of a data volume and a delay status associated with the data volume.

The determination component 808 may determine that the set of criteria for delay status reporting is satisfied. The report generation component 810 may generate the delay status report based at least in part on determining that the set of criteria for delay status reporting is satisfied. The reception component 802 may receive signaling associated with configuring one or more parameters of the delay status report.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

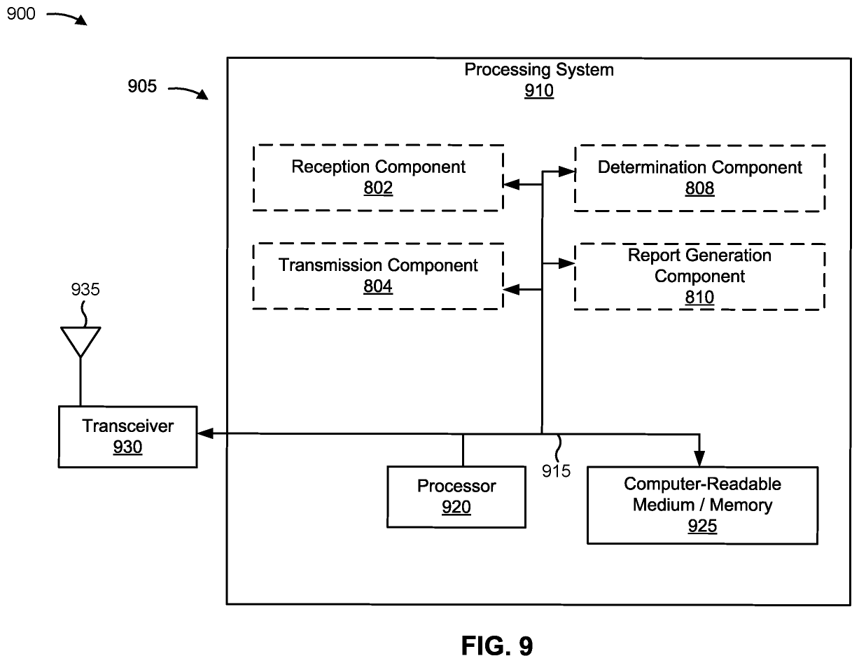

FIG. 9 is a diagram illustrating an example 900 of a hardware implementation for an apparatus 905 employing a processing system 910, in accordance with the present disclosure. The apparatus 905 may be a UE.

The processing system 910 may be implemented with a bus architecture, represented generally by the bus 915. The bus 915 may include any number of interconnecting buses and bridges depending on the specific application of the processing system 910 and the overall design constraints. The bus 915 links together various circuits including one or more processors and/or hardware components, represented by the processor 920, the illustrated components, and the computer-readable medium/memory 925. The bus 915 may also link various other circuits, such as timing sources, peripherals, voltage regulators, and/or power management circuits.

The processing system 910 may be coupled to a transceiver 930. The transceiver 930 is coupled to one or more antennas 935. The transceiver 930 provides a means for communicating with various other apparatuses over a transmission medium. The transceiver 930 receives a signal from the one or more antennas 935, extracts information from the received signal, and provides the extracted information to the processing system 910, specifically the reception component 802. In addition, the transceiver 930 receives information from the processing system 910, specifically the transmission component 804, and generates a signal to be applied to the one or more antennas 935 based at least in part on the received information.

The processing system 910 includes a processor 920 coupled to a computer-readable medium/memory 925. The processor 920 is responsible for general processing, including the execution of software stored on the computer-readable medium/memory 925. The software, when executed by the processor 920, causes the processing system 910 to perform the various functions described herein for any particular apparatus. The computer-readable medium/memory 925 may also be used for storing data that is manipulated by the processor 920 when executing software. The processing system further includes at least one of the illustrated components. The components may be software modules running in the processor 920, resident/stored in the computer readable medium/memory 925, one or more hardware modules coupled to the processor 920, or some combination thereof.

In some aspects, the processing system 910 may be a component of the UE 120 and may include the memory 282 and/or at least one of the TX MIMO processor 266, the receive (RX) processor 258, and/or the controller/processor 280. In some aspects, the apparatus 905 for wireless communication includes means for receiving information identifying a set of criteria for delay status reporting: and/or means for transmitting, based at least in part on the set of criteria being satisfied, a delay status report including an indicator of a data volume and a delay status associated with the data volume. The aforementioned means may be one or more of the aforementioned components of the apparatus 800 and/or the processing system 910 of the apparatus 905 configured to perform the functions recited by the aforementioned means. As described elsewhere herein, the processing system 910 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 9 is provided as an example. Other examples may differ from what is described in connection with FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a determination component 1008, among other examples.

In some aspects, the apparatus 1000 may be configured to perform one or more operations described herein, such as one or more operations described with regard to FIGS. 5A and 5B. Additionally, or alternatively, the apparatus 1000 may be configured to perform one or more processes described herein, such as method 700 of FIG. 7. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit information identifying a set of criteria for delay status reporting. The reception component 1002 may receive, based at least in part on the set of criteria being satisfied, a delay status report including an indicator of a data volume and a delay status associated with the data volume. The transmission component 1004 may transmit signaling associated with configuring one or more parameters of the delay status report. The determination component 1008 may determine the set of criteria for delay status reporting.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

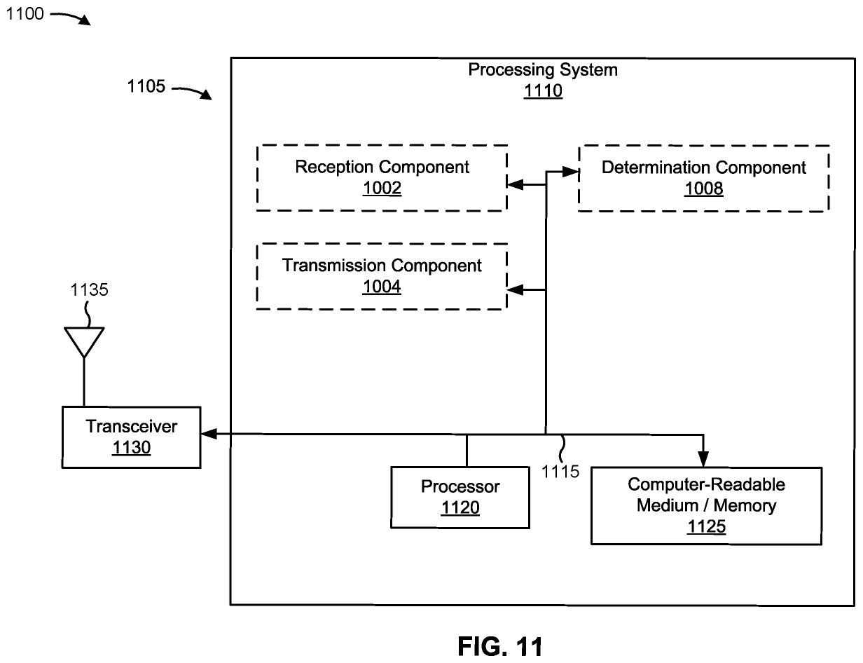

FIG. 11 is a diagram illustrating an example 1100 of a hardware implementation for an apparatus 1105 employing a processing system 1110, in accordance with the present disclosure. The apparatus 1105 may be a network node.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the network node 110 and may include the memory 242 and/or at least one of the TX MIMO processor 230, the RX processor 238, and/or the controller/processor 240. In some aspects, the apparatus 1105 for wireless communication includes means for transmitting information identifying a set of criteria for delay status reporting: and/or means for receiving, based at least in part on the set of criteria being satisfied, a delay status report including an indicator of a data volume and a delay status associated with the data volume. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 11 is provided as an example. Other examples may differ from what is described in connection with FIG. 11.

The following provides an overview of some Aspects of the present disclosure:

Aspect 1: A method of wireless communication performed by a user equipment (UE), comprising: receiving information identifying a set of criteria for delay status reporting: and transmitting, based at least in part on the set of criteria being satisfied, a delay status report including an indicator of a data volume and a delay status associated with the data volume.

Aspect 2: The method of Aspect 1, further comprising: determining that the set of criteria for delay status reporting is satisfied: and generating the delay status report based at least in part on determining that the set of criteria for delay status reporting is satisfied.

Aspect 3: The method of any of Aspects 1-2, wherein the delay status reporting is associated with at least one of: a data radio bearer, a logical channel, or a logical channel group.

Aspect 4: The method of any of Aspects 1-3, wherein the delay status is based at least in part on a delay deadline for a protocol data unit associated with the data volume or on a packet delay budget associated with a quality of service flow, the quality of service flow including the protocol data unit.

Aspect 5: The method of any of Aspects 1-4, wherein the delay status is based at least in part on a time threshold for triggering generation of the delay status report or for reporting the delay status report.

Aspect 6: The method of any of Aspects 1-5, further comprising: receiving signaling associated with configuring one or more parameters of the delay status report.

Aspect 7: The method of Aspect 6, wherein the one or more parameters include at least one of: a data volume threshold parameter, a timer parameter, or one or more reporting thresholds.

Aspect 8: The method of any of Aspects 1-7, wherein the delay status report is based at least in part on whether a threshold data volume is associated with a remaining time, wherein the remaining time is less than a time threshold.

Aspect 9: The method of any of Aspects 1-8, wherein the delay status report is based at least in part on a data volume reported in a previous delay status report.

Aspect 10: The method of any of Aspects 1-9, wherein the delay status report is based at least in part on a status of a timer.

Aspect 11: The method of Aspect 10, wherein the timer is stopped based at least in part on transmission of the delay status report.

Aspect 12: The method of any of Aspects 1-11, wherein the delay status report is based at least in part on a configured periodicity.

Aspect 13: The method of Aspect 12, wherein the configured periodicity is associated with a reporting entity.

Aspect 14: The method of any of Aspects 1-13, wherein the delay status report is based at least in part on an occurrence of a mobility event.

Aspect 15: The method of any of Aspects 1-14, wherein the delay status report is included in a medium access control (MAC) control element (CE).

Aspect 16: The method of Aspect 15, wherein the MAC CE includes at least one of: a delay status report reporting entity bitmap, a buffer status report table bitmap, an indicator of data with a remaining time within a configured range, an indicator of data with a remaining time less than a threshold, an indicator that the MAC CE is for a reporting entity, an indicator of a buffer status report table, a sampling instance duration indicator, or a transmission time indicator.

Aspect 17: The method of any of Aspects 1-16, wherein the delay status report is associated with a first priority that is higher than a second priority of a buffer status report.

Aspect 18: The method of any of Aspects 1-17, wherein the delay status report is multiplexed onto a physical uplink shared channel resource.

Aspect 19: The method of any of Aspects 1-18, wherein the delay status report is included in a physical uplink shared channel resource requested via a scheduling request.

Aspect 20: A method of wireless communication performed by a network node, comprising: transmitting information identifying a set of criteria for delay status reporting: and receiving, based at least in part on the set of criteria being satisfied, a delay status report including an indicator of a data volume and a delay status associated with the data volume.

Aspect 21: The method of Aspect 20, wherein the delay status reporting is associated with at least one of: a data radio bearer, a logical channel, or a logical channel group.

Aspect 22: The method of any of Aspects 20-21, wherein the delay status is based at least in part on a delay deadline for a protocol data unit associated with the data volume or on a packet delay budget associated with a quality of service flow, the quality of service flow including the protocol data unit.

Aspect 23: The method of any of Aspects 20-22, wherein the delay status is based at least in part on a time threshold for triggering generation of the delay status report or for reporting the delay status report.

Aspect 24: The method of any of Aspects 20-23, further comprising: transmitting signaling associated with configuring one or more parameters of the delay status report.

Aspect 25: The method of Aspect 24, wherein the one or more parameters include at least one of: a data volume threshold parameter, a timer parameter, or one or more reporting thresholds.

Aspect 26: The method of any of Aspects 20-25, wherein the delay status report is based at least in part on whether a threshold data volume is associated with a remaining time, wherein the remaining time is less than a time threshold.

Aspect 27: The method of any of Aspects 20-26, wherein the delay status report is based at least in part on a data volume reported in a previous delay status report.

Aspect 28: The method of any of Aspects 20-27, wherein the delay status report is based at least in part on a status of a timer.

Aspect 29: The method of Aspect 28, wherein the timer is stopped based at least in part on transmission of the delay status report.

Aspect 30: The method of any of Aspects 20-29, wherein the delay status report is based at least in part on a configured periodicity.

Aspect 31: The method of Aspect 30, wherein the configured periodicity is associated with a reporting entity.

Aspect 32: The method of any of Aspects 20-31, wherein the delay status report is based at least in part on an occurrence of a mobility event.

Aspect 33: The method of any of Aspects 20-32, wherein the delay status report is included in a medium access control (MAC) control element (CE).

Aspect 34: The method of Aspect 33, wherein the MAC CE includes at least one of: a delay status report reporting entity bitmap, a buffer status report table bitmap, an indicator of data with a remaining time within a configured range, an indicator of data with a remaining time less than a threshold, an indicator that the MAC CE is for a reporting entity, an indicator of a buffer status report table, a sampling instance duration indicator, or a transmission time indicator.

Aspect 35: The method of any of Aspects 20-34, wherein the delay status report is associated with a first priority that is higher than a second priority of a buffer status report.

Aspect 36: The method of any of Aspects 20-35, wherein the delay status report is multiplexed onto a physical uplink shared channel resource.

Aspect 37: The method of any of Aspects 20-36, wherein the delay status report is included in a physical uplink shared channel resource requested via a scheduling request.

Aspect 38: An apparatus for wireless communication at a device, comprising a processor: memory coupled with the processor: and instructions stored in the memory and executable by the processor to cause the apparatus to perform the method of one or more of Aspects 1-37.

Aspect 39: A device for wireless communication, comprising a memory and one or more processors coupled to the memory, the one or more processors configured to perform the method of one or more of Aspects 1-37.

Aspect 40: An apparatus for wireless communication, comprising at least one means for performing the method of one or more of Aspects 1-37.

Aspect 41: A non-transitory computer-readable medium storing code for wireless communication, the code comprising instructions executable by a processor to perform the method of one or more of Aspects 1-37.

Aspect 42: A non-transitory computer-readable medium storing a set of instructions for wireless communication, the set of instructions comprising one or more instructions that, when executed by one or more processors of a device, cause the device to perform the method of one or more of Aspects 1-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein. “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example. “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, the one or more processors configured to:
receive information identifying a set of criteria for delay status reporting; and
transmit based at least in part on the set of criteria being satisfied, a delay status report including an indicator of a data volume and a delay status associated with the data volume.

2. The UE of claim 1, wherein the one or more processors are further configured to:
determine that the set of criteria for delay status reporting is satisfied; and
generate the delay status report based at least in part on determining that the set of criteria for delay status reporting is satisfied.

3. The UE of claim 1, wherein the delay status reporting is associated with at least one of:
a data radio bearer,
a logical channel, or
a logical channel group.

4. The UE of claim 1, wherein the delay status is based at least in part on a delay deadline for a protocol data unit associated with the data volume or on a packet delay budget associated with a quality of service flow, the quality of service flow including the protocol data unit.

5. The UE of claim 1, wherein the delay status is based at least in part on a time threshold for triggering generation of the delay status report or for reporting the delay status report.

6. The UE of claim 1, wherein the one or more processors are further configured to:
receive signaling associated with configuring one or more parameters of the delay status report.

7. The UE of claim 6, wherein the one or more parameters include at least one of:
a data volume threshold parameter,
a timer parameter, or
one or more reporting thresholds.

8. The UE of claim 1, wherein the delay status report is based at least in part on whether a threshold data volume is associated with a remaining time, wherein the remaining time is less than a time threshold.

9. The UE of claim 1, wherein the delay status report is based at least in part on a data volume reported in a previous delay status report.

10. The UE of claim 1, wherein the delay status report is based at least in part on a status of a timer.

11. The UE of claim 10, wherein the timer is stopped based at least in part on transmission of the delay status report.

12. The UE of claim 1, wherein the delay status report is based at least in part on a configured periodicity.

13. The UE of claim 12, wherein the configured periodicity is associated with a reporting entity.

14. The UE of claim 1, wherein the delay status report is based at least in part on an occurrence of a mobility event.

15. The UE of claim 1, wherein the delay status report is included in a medium access control (MAC) control element (CE).

16. The UE of claim 15, wherein the MAC CE includes at least one of:
a delay status report reporting entity bitmap,
a buffer status report table bitmap,
an indicator of data with a remaining time within a configured range,
an indicator of data with a remaining time less than a threshold,
an indicator that the MAC CE is for a reporting entity,
an indicator of a buffer status report table,
a sampling instance duration indicator, or
a transmission time indicator.

17. The UE of claim 1, wherein the delay status report is associated with a first priority that is higher than a second priority of a buffer status report.

18. The UE of claim 1, wherein the delay status report is multiplexed onto a physical uplink shared channel resource.

19. The UE of claim 1, wherein the delay status report is included in a physical uplink shared channel resource requested via a scheduling request.

20. A network node for wireless communication, comprising:
one or more memories; and
one or more processors, coupled to the one or more memories, the one or more processors configured to:
transmit information identifying a set of criteria for delay status reporting; and
receive, based at least in part on the set of criteria being satisfied, a delay status report including an indicator of a data volume and a delay status associated with the data volume.

21. The network node of claim 20, wherein the delay status reporting is associated with at least one of:
a data radio bearer,
a logical channel, or
a logical channel group.

22. The network node of claim 20, wherein the delay status is based at least in part on a delay deadline for a protocol data unit associated with the data volume or on a packet delay budget associated with a quality of service flow, the quality of service flow including the protocol data unit.

23. The network node of claim 20, wherein the delay status is based at least in part on a time threshold for triggering generation of the delay status report or for reporting the delay status report.

24. The network node of claim 20, wherein the one or more processors are further configured to:
transmit signaling associated with configuring one or more parameters of the delay status report.

25. The network node of claim 24, wherein the one or more parameters include at least one of:
a data volume threshold parameter,
a timer parameter, or
one or more reporting thresholds.

26. The network node of claim 20, wherein the delay status report is based at least in part on whether a threshold data volume is associated with a remaining time, wherein the remaining time is less than a time threshold.

27. The network node of claim 20, wherein the delay status report is based at least in part on a data volume reported in a previous delay status report.

28. The network node of claim 20, wherein the delay status report is based at least in part on a status of a timer.

29. A method of wireless communication performed by a user equipment (UE), comprising:
receiving information identifying a set of criteria for delay status reporting; and
transmitting, based at least in part on the set of criteria being satisfied, a delay status report including an indicator of a data volume and a delay status associated with the data volume.

30. A method of wireless communication performed by a network node, comprising:
transmitting information identifying a set of criteria for delay status reporting; and
receiving, based at least in part on the set of criteria being satisfied, a delay status report including an indicator of a data volume and a delay status associated with the data volume.
